(19) United States
(12) Patent Application Publication
(10) Pub. No.: US 2018/0025286 A1
(43) Pub. Date: Jan. 25, 2018

(54) DETECTING TRENDS IN EVOLVING ANALYTICS MODELS

(71) Applicant: International Business Machines Corporation, Armonk, NY (US)

(72) Inventors: Leonid Gorelik, Petah Tikva (IL); Nancy L. Navarro, Rockville, MD (US); Srinivasan Parthasarathy, White Plains, NY (US); Alexander Pyasik, Maaleh-Adumim (IL); Yifat Yulevich, Kfar Daniel (IL)

(21) Appl. No.: 15/218,316

(22) Filed: Jul. 25, 2016

(51) Int. Cl. G06N 99/00; G06F 17/50

(52) U.S. Cl. CPC G06N 99/005; G06F 17/50

(57) ABSTRACT

A computer-implemented method includes receiving data representing pre-existing instances of an analytics model developed over time; detecting changes in state of the analytics model over time to detect trends; generating a new instance of the analytics model that has been modified based on detected trends in the analytics model; generating new training data based on discovered trends of the analytics model over time; comparing a coverage of the new instance of the analytics model and coverages of the pre-existing instances of the analytics model with the new training data; and determining whether new instance of the analytics model have better coverage than the pre-existing instances of the analytics model with the new training data. A corresponding computer program product and system are also disclosed.

### BACKGROUND

The present invention relates generally to data analytics, and more particularly to techniques for detecting trends in analytics models that change over time.

In analytics models that change over time, detecting data trends can be difficult. In such evolving models, the changing nature of data makes it a challenge to determine an appropriate strategy for training of data over time. Developers and users of computer products relying on data analytics of evolving analytical models continue to face difficulties associated with detecting trends in such models.

### SUMMARY

A computer-implemented method includes receiving data representing pre-existing instances of an analytics model developed over time; detecting changes in state of the analytics model over time to detect trends; generating a new instance of the analytics model that has been modified based on detected trends in the analytics model; generating new training data based on discovered trends of the analytics model over time; comparing a coverage of the new instance of the analytics model and coverages of the pre-existing instances of the analytics model with the new training data; and determining whether new instance of the analytics model have better coverage than the pre-existing instances of the analytics model with the new training data. A corresponding computer program product and system are also disclosed.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary flow diagram of a processing system that may be used for detecting trends in analytics models that change over time.

FIG. 2 is an exemplary block diagram of a model checkpoint.

FIG. 3 is an exemplary data flow diagram of a process of detecting trends in evolving analytics models.

FIG. 4 is exemplary block diagram of a computer system, in which the processes involved in the embodiments described herein may be implemented.

### DETAILED DESCRIPTION

Analytics is the discovery and communication of meaningful patterns in data. Analytics may rely on a number of data analysis techniques, such as statistics, computer programming, and operations research discover patterns. Analytics today is being applied in many different domains. Some domains are very dynamic and require frequent retraining and improvement of analytics supervised learning models to keep solving problems and align with new data behavioral trends. Supervised learning models are based on labeled training data. The training process results in the creation of a new model instance, allowing the system to score and classify the data. Model instances for dynamic systems must be retrained frequently to cope with new behavior trends reflected in the data. In some very dynamic domains, such as cybersecurity, the behavioral trends change very frequently. This leads to inaccuracy and misidentification of suspicious activities.

Today, systems exist that allow model retraining and improvement by providing new training data. Such systems still lack the ability to provide a broad picture of model instance trends. Understanding the over time, model instance trends can help to improve the generated predictive models and extend their usefulness for a longer period of time and wider coverage.

Existing work surrounding model trends analysis has not considered analysis of the trends reflected by a sequence of model instances. In this invention we propose to create a predictive model and generate predictive training data from previous model instances.

Embodiments of the present invention may provide the capability to detect trends in analytics models that change over time. This may improve supervised-learning analytic models and allow the models to be operational and valid for increased periods of time. The changes in the model may be analyzed over time. Based on that analysis, a new predictive model and new predictive training data may be generated. In addition, information regarding the evolving model trends may be provided.

The level of sophistication of supervised model training may be increased by leveraging current and historical model instances and the learning over-time trends of supervised model instances. This may increase the accuracy of the new model instance and may create new predictive training data as well as over-time perspective insights of model instance trends. The accuracy of an existing model may be improved by taking into consideration the way that the existing model evolves over time, allowing the model to have broader coverage and higher accuracy.

Embodiments of the present invention may be valuable to many different domains. For example, in cybersecurity, knowing in advance new behavioral model instance trends may help organizations protect their assets from undiscovered malicious activities. In fraud detection, it will provide more accurate models with a wider coverage. In transportation it may be used to create better predictive models for passenger transportation. For utilities, it may improve predictions of energy consumption.

Embodiments of the present invention may provide the capability to detect trends in analytics models that change over time. This may improve supervised-learning analytic models and allow the models to be operational and valid for increased periods of time. The changes in the model may be analyzed over time. Based on that analysis, a new predictive model and new predictive training data may be generated. In addition, information regarding the evolving model trends, over time, may be provided.

In an embodiment of the present invention, a method for detecting trends in an analytics model may comprise receiving data representing instances of an analytics model developed over time (i.e., “pre-existing” analytics model), detecting changes in the state of the analytics model over time to detect trends, generating a new instance of the analytics model that has been modified based on the detected trends in the analytics model, generating new training data that based on the discovered trends of the analytics model over time, and comparing a coverage of the new instance of the analytics model with coverages of the other instances of the analytics model to determine that the new instance of the analytics model has better coverage than the other instances of the analytics model based on the new generated training data.

In an embodiment, the present invention includes a method comprising: receiving data representing pre-existing instances of an analytics model developed over time; detecting changes in state of the analytics model over time to detect trends; generating a new instance of the analytics model that has been modified based on detected trends in the analytics model; generating new training data based on discovered trends of the analytics model over time; comparing a coverage of the new instance of the analytics model and coverages of the pre-existing instances of the analytics model with the new training data; and determining whether new instance of the analytics model have better coverage than the pre-existing instances of the analytics model with the new training data. In an embodiment, the method further comprises identifying one or more training sets, the one or more training being a part of a current model checkpoint object; and identifying one or more over-time model trends; wherein the new training data is generated by using data generator functions to combine the one or more training sets with one or more over-time model trends.

The analytics model may include behavioral data. The analytics model may be modified so as to reflect changes in the behavioral data. The analytics model may further include an analytic component having associated metadata containing a description of an analytic technique used by the analytics model, assumptions required for the analytic technique to be valid, constraints on the analytics model, and sensitivities of the analytics model, a definition of a type of data on which the analytics model operates, and a definition of an output the analytics model produces. The coverage of the new instance of the analytics model may be compared with the coverage of at least one other instance of the analytics model using a statistical test. The statistical test may be an F-test. The new training data may be generated using data generator functions that combine the training sets (which is part of the current Model Checkpoint Object) with one or more Over-Time Model Trends to create the new predictive training data.

In an embodiment of the present invention, a system for detecting trends in an analytics model may comprise a processor, memory accessible by the processor, and computer program instructions stored in the memory and executable by the processor to perform receiving data representing instances of an analytics model developed over time, detecting changes in the state of the analytics model over time to detect trends, generating a new instance of the analytics model that has been modified based on the detected trends in the analytics model, generating new training data with data generation function based on the discovered trends of the analytics model over time, and comparing a coverage of the new instance of the analytics model with coverages of the other model instances of the analytics model to determine that the new instance of the analytics model has better coverage than the other instances of the analytics model based on the new generated training data.

In an embodiment of the present invention, a computer program product for detecting trends in an analytics model may comprise a non-transitory computer readable storage having program instructions embodied therewith, the program instructions executable by a computer, to cause the computer to perform a method comprising receiving data representing instances of an analytics model developed over time, detecting changes in the state of the analytics model over time to detect trends, generating a new instance of the analytics model that has been modified based on the detected trends in the analytics model, generating new training data that based on the discovered trends of the analytics model over time, and comparing a coverage of the new instance of the analytics model with coverages of the other instances of the analytics model to determine that the new instance of the analytics model has better coverage than the other instances of the analytics model based on the new generated training data. In an embodiment, new training data may be generated using data generator functions that combine the training sets (which is part of the current Model Checkpoint Object) with the Over-Time Model Trends to create the new predictive training data.

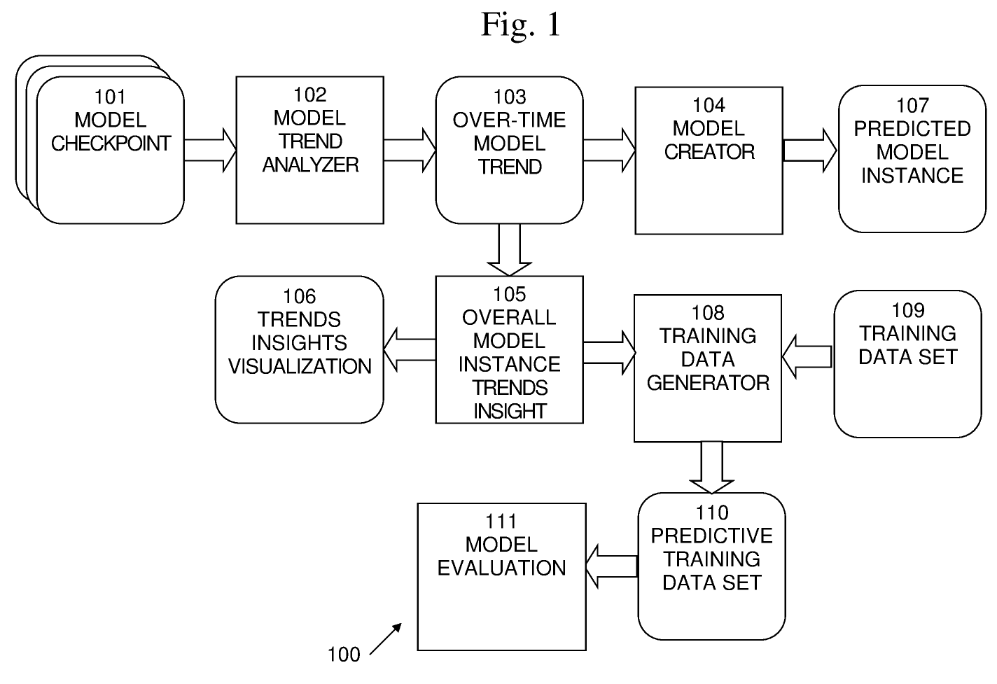

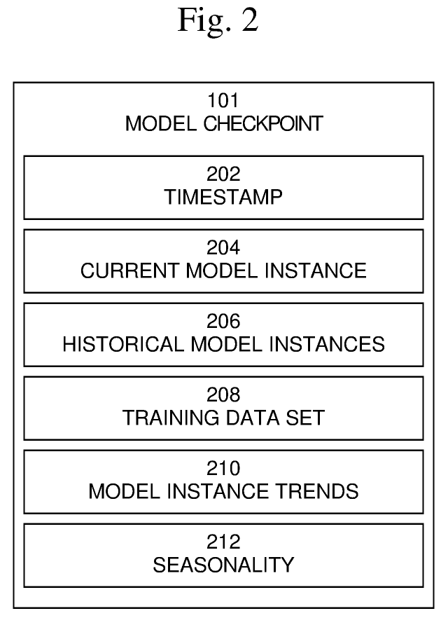

An example of a processing system 100 for detecting trends in analytics models that change over time is shown in FIG. 1. System 100 may receive historical model instances and training sets as embodied in one or more Model Checkpoint 101. Typically, model checkpoints are saved snapshots of the state of one or more analytics models and may include all data necessary to start or restart processing of the model from the point at which the snapshot was taken. Preserving the snapshots is useful for traceability as well as future iteration input data. An example of a Model Checkpoint 101 is shown in FIG. 2. In this example, Model Checkpoint 101 may be a data object that contains information including timestamp 202, current model instance 204, historical model instances 206, training data set 208, model instance trends 210, and seasonality information 212.

Several processes included in system 100 may then be used to generate output information, such as Predictive Model Instances 107, Predictive Training Data Set 110, and Overall Model Instance Trends Insights 105.

As one example, Model Trend Analyzer 102 receives one or more Model Checkpoints 101 and analyzes one or more historical model instances with each instance's corresponding training data set, as provided by the Model Checkpoints 101, to discover and output Over-Time Model Trend 103. Model Trend Analyzer 102 may look for trends and other aspects (such as seasonality 212) in current 204 and historical model instances 206. Examples of implementation approaches may include parametric and non-parametric trend estimation techniques, such as rough estimates of trends using, for example, a Kalman filter, seasonality detection techniques, such as a Butterworth filter, and classical decomposition models for a seasonal time series. Decomposition may allow creation of an explicit representation composed of the underlying trend, seasonal variation, and irregular (random) noise components.

Over-Time Model Trend 103 may be passed to Model Creator 104 component, which may generate Predicted Model Instance 107. Model Creator 104 may generate a new predicted model instance based on the model trends detected by the Model Trend Analyzer 102, as included in Over-Time Model Trend 103. Model Creator 104 may fit Model Trend Analyzer 102 results to form a new model instance named “Predictive Model Instance” 107 that has been modified, at least in part, based on Over-Time Model Trend 103.

Utilizing the newly created Predicted Model Instance 107, as well as the given Training Data Set 109, Training Data Generator 108 may generate a Predictive Training Data Set 110 that reflects the behavior data trends. Predictive Training Data Set 110 may be a Training Data Set that is generated by the Training Data Generator 108, using generation functions based on an existing training data set combined with the new Predictive Model Instance 107. The Predictive Training Set 110 may be used to evaluate previously created model instances, and may help to determine how those previously created model instances will score/classify the predicted data.

Training Data Generator 108 may use data generator functions to combine the training sets (which are part of the current Model Checkpoint Object) with the Over-Time Model Trends 103 to create the new predictive training data. This may become Predictive Training Data Set 110. Predictive Training Data Set 110 may then be used by Model Evaluation 111 for evaluation and testing of created model instances, such as the current model instance, in order to determine how well such model instances perform compared to the Predicted Model Instance 107, using the new Predictive Training Data Set 110. Model Evaluation 111 compares models based on model coverage, for example, using a statistical test such as the F-Test.

In addition, system 100 may generate Trends Insights Visualization 106 using Overall Model Instance Trends Insights 105, which may give a broad view on field vector value changes in behavior and trends, providing a long term view of the model's instances trend and helping to focus on new directions in the domain fields.

An analytics model may include an analytic component having, for example, associated metadata containing information such as a description of the analytic technique used, assumptions required for the analytic technique to be valid, constraints and sensitivities, the definition of the type of data on which the model operates, and a definition of the output the model produces.

A model instance may involve the execution of a model on a particular input data set and the production of an output based on those inputs. For any given model, there may be many model instances depending on the frequency with which the model is executed. How long time period the output of a model instance may be considered valid may depend on a number of factors, included, but not limited to, the frequency with which the input data changes and the amount of quantitative change in the input data. If the analytic component of a model is revised, then a new version of the model is said to be created. Model instances for this new version of the model are generated when the new version is executed.

Training Data Set 109 may be used in supervised learning procedures, such as classification of records or prediction of target values. A training data set is a portion of a data set that may be used to fit or train a model for prediction or classification. The training data set may be labeled data that is provided to the analytics model allowing creation of a model instance that is capable of predicting and/or classifying the data based on values of the predictors. Those predictors may then be used for scoring and classification. The training set may be used in conjunction with validation and/or test data sets that may be used to evaluate model instances.

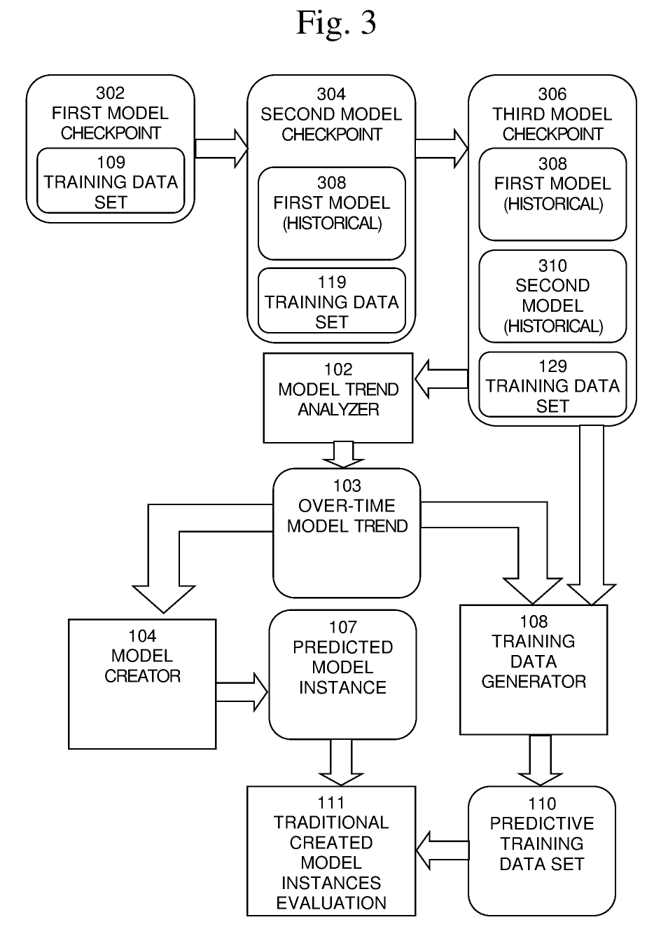

A simple example of detecting trends in evolving analytics models is shown in FIG. 3. In this example, a decision tree illustrates domain name server (DNS) traffic classification for fast flux detection. A decision tree is applied on a single DNS response feature vector, with results labeled as either benign or fast flux. The following code snippets are in Predictive Model Markup Language (PMML) notation.

In a first simple exemplary model checkpoint 302, the definition of node 1 is as follows:

<Node id=“1” score=“0” recordCount=“8.0”>

```
  <SimplePredicate field=“field17” operator=“lessOrEqual”
  value=“3.0”/>
<ScoreDistribution value=“0” recordCount=“7.0”/>
<ScoreDistribution value=“1” recordCount=“1.0”/>
```

</Node>

In a second simple exemplary model checkpoint 304, the value attribute in the predicate definition for field 17 changes to 8:

<Node id=“1” score=“0” recordCount=“8.0”>

```
  <SimplePredicate field=“field17” operator=“lessOrEqual”
  value=“8.0”/>
<ScoreDistribution value=“0” recordCount=“7.0”/>
<ScoreDistribution value=“1” recordCount=“1.0”/>
```

</Node>

Second model checkpoint 304 contains the current (second) model as well as the first model 308 as a historical model and the second training set 119.

Finally, in a third simple exemplary model checkpoint 306, the value attribute changes to 13. Third model checkpoint 306 contains the current (third) model as well as the first model 308 and second model 310 as historical models. In addition, it includes the third training set 129.

<Node id=“1” score=“0” recordCount=“8.0”>

```
  <SimplePredicate field=“field17” operator=“lessOrEqual”
  value=“13.0”/>
<ScoreDistribution value=“0” recordCount=“7.0”/>
<ScoreDistribution value=“1” recordCount=“1.0”/>
```

</Node>

In those simple examples when Model Trend Analyzer 102 processes the current model checkpoint, third model checkpoint 306, it detects as the Over-Time Model Trend 103 f(x)=x+5, and Model Creator 104 generates the following code snippet as part of Predicted Model Instance 107:

<Node id=“1” score=“0” recordCount=“8.0”>

```
  <SimplePredicate field=“field17” operator=“lessOrEqual”
  value=“18.0”/>
<ScoreDistribution value=“0” recordCount=“7.0”/>
<ScoreDistribution value=“1” recordCount=“1.0”/>
```

</Node>

Training Data Generator 108 then generates new Predictive Training Data Set 110 by using data generator functions that combine the training sets 129 (which are part of the current Model Checkpoint Object) (third) with the Over-Time Model Trends 103 to create the new predictive training data. This may become Predictive Training Data Set 110.

For example, a feature vector of the DNS response that was previously classified as benign might be classified differently with the new predicted model instance.

Finally, the Model Evaluation 111 runs Predicted Model Instance 107 and the current (third) and historical (first and second) model instances on the new Predictive Training Data Set 110 as well as the current checkpoint training set, and identifies the model instance with the best coverage. The model instance with the best coverage may then replace the current model instance and become the new current model instance. For example, the newly created Predicted Model Instance 107 may show 80% coverage, while the best previous model instance may show 70% coverage. The newly created Predicted Model Instance 107 may therefore become the current active model instance.

A new model checkpoint may therefore consist of the latest current model instance, Predicted Model Instance 107, the current training set, Predictive Training Data Set 110, and the updated model instance trends, seasonality, timestamp, and historical model instances.

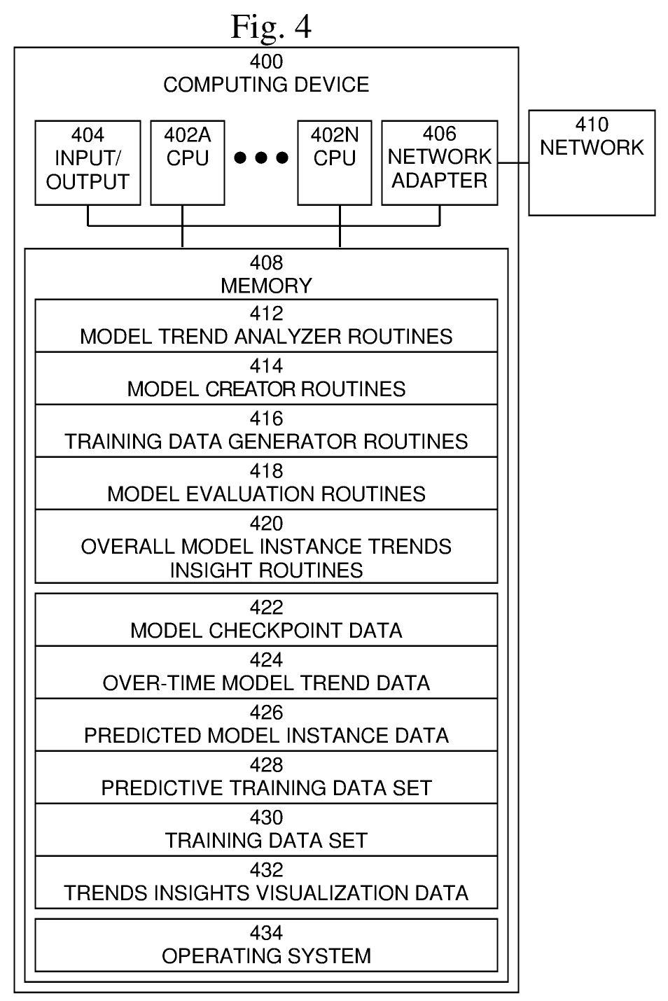

An exemplary block diagram of a computer system 400, in which the processes involved in the embodiments described herein may be implemented, is shown in FIG. 4. Computer system 400 is typically a programmed general-purpose computer system, such as a personal computer, workstation, server system, and minicomputer or mainframe computer. Computer system 400 may include one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which computer system 400 is implemented as a single multi-processor computer system, in which multiple processors 402A-402N share system resources, such as memory 408, input/output circuitry 404, and network adapter 406. However, the present invention also contemplates embodiments in which computer system 400 is implemented as a plurality of networked computer systems, which may be single-processor computer systems, multi-processor computer systems, or a mix thereof.

Likewise, it is understood that although this disclosure includes a detailed description on premises computing and software, implementation of the teachings recited herein is not limited to that computing environment. Rather, embodiments of the present invention are capable of being implemented on cloud computing systems or in conjunction with any other type of computing environment now known or later developed. Cloud computing is a model of network-based computing that provides shared processing resources and data to computers and other devices on demand.

Input/output circuitry 404 provides the capability to input data to, or output data from, computer system 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces device 400 with a network 410. Network 410 may be any public or proprietary LAN or WAN, including, but not limited to the Internet.

Memory 408 stores program instructions that are executed by, and data that are used and processed by, CPU 402 to perform the functions of computer system 400. Memory 408 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 408 may vary depending upon the function that computer system 400 is programmed to perform. For example, as shown in FIG. 1, computer systems may perform a variety of roles in the system, method, and computer program product described herein. For example, computer systems may perform one or more roles as users, validators, auditors, and/or identity providers. In the example shown in FIG. 4, exemplary memory contents are shown representing routines for all of these roles. However, one of skill in the art would recognize that these routines, along with the memory contents related to those routines, may be included on one system, or may be distributed among a plurality of systems, based on well-known engineering considerations. The present invention contemplates any and all such arrangements.

In the example shown in FIG. 4, memory 408 may include Model Trend Analyzer Routines 412, Model Creator Routines 414, Training Data Generator Routines 416, Model Evaluation Routines 418, Overall Model Instance Trends Insight Routines 420, Model Checkpoint Data 422, Over-Time Model Trend Data 424, Predicted Model Instance Data 426, Predictive Training Data Set 428, Training Data Set 430, Trends Insights Visualization Data 432, and operating system 424. Model Trend Analyzer Routines 412 may include routines to look for trends and other aspects (such as seasonality) in current and historical model instances. Model Creator Routines 414 may include routines to generate a new predicted model instance based on the model trends detected by the Model Trend Routines 412. Training Data Generator Routines 416 may include routines to receive labeling information that may be provided by a user to some members of the cluster. Model Evaluation Routines 418 may include routines to compare models based on model coverage, for example, using a statistical test such as the F-Test. Overall Model Instance Trends Insight Routines 420 may include routines to generate Trends Insights Visualization Data 432, which may give a broad view on field vector value changes in behavior and trends, providing a long term view of the model's instances trend and helping to focus on new directions in the domain fields. Model Checkpoint Data 422 may include data such as saved snapshots of the state of one or more analytics models and may include all data necessary to start or restart processing of the model from the point at which the snapshot was taken, as well as data such as information including a timestamp, a current model instance, historical model instances, a training data set, model instance trends and seasonality information 212. Over-Time Model Trend Data 424 may include data representing trends in changes to analytics models, such as underlying trends, seasonal variation, and irregular (random) noise components. Predicted Model Instance Data 426 may include data representing a generated model instance that has been modified, at least in part, based on Over-Time Model Trend Data 424. Predictive Training Data Set 428 may include data representing a training data set generated based on an existing training data set combined with the new Predictive Model Instance Data 426. Training Data Set 430 may include data representing one or more existing training data sets. Operating system 432 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for detecting trends in an analytics model comprising:
receiving data representing pre-existing instances of an analytics model developed over time;
detecting changes in state of the analytics model over time to detect trends;
generating a new instance of the analytics model that has been modified based on detected trends in the analytics model;
generating new training data based on discovered trends of the analytics model over time;
comparing a coverage of the new instance of the analytics model and coverages of the pre-existing instances of the analytics model with the new training data; and
determining whether new instance of the analytics model have better coverage than the pre-existing instances of the analytics model with the new training data.

2. The method of claim 1, wherein the analytics model comprises behavioral data.

3. The method of claim 2, wherein the analytics model is modified so as to reflect changes in the behavioral data.

4. The method of claim 2, wherein the analytics model further comprises an analytic component, the analytic component being associated with metadata, wherein the metadata comprises a description of an analytic technique used by the analytics model, assumptions required for the analytic technique to be valid, constraints on the analytics model, sensitivities of the analytics model, a definition of a type of data on which the analytics model operates, and a definition of an output the analytics model produces.

5. The method of claim 1, wherein the coverage of the new instance of the analytics model is compared with the coverage of at least one other instance of the analytics model using a statistical test.

6. The method of claim 5, wherein the statistical test is an F-test.

7. The method of claim 1, further comprising:
identifying one or more training sets, the one or more training being a part of a current model checkpoint object;
identifying one or more over-time model trends; and
wherein the new training data is generated by using data generator functions to combine the one or more training sets with one or more over-time model trends.

8. A computer system for detecting trends in an analytics model, the system comprising a processor, memory accessible by the processor, and computer program instructions stored in the memory and executable by the processor to perform:
receiving data representing pre-existing instances of an analytics model developed over time;
detecting changes in state of the analytics model over time to detect trends;
generating a new instance of the analytics model that has been modified based on detected trends in the analytics model;
generating new training data based on discovered trends of the analytics model over time;
comparing a coverage of the new instance of the analytics model and coverages of the pre-existing instances of the analytics model with the new training data; and
determining whether new instance of the analytics model have better coverage than the pre-existing instances of the analytics model with the new training data.

9. The computer system of claim 8, wherein the analytics model comprises behavioral data.

10. The computer system of claim 9, wherein the analytics model is modified so as to reflect changes in the behavioral data.

11. The computer system of claim 9, wherein the analytics model further comprises an analytic component, the analytic component being associated with metadata, wherein the metadata comprises a description of an analytic technique used by the analytics model, assumptions required for the analytic technique to be valid, constraints on the analytics model, sensitivities of the analytics model, a definition of a type of data on which the analytics model operates, and a definition of an output the analytics model produces.

12. The computer system of claim 8, wherein the coverage of the new instance of the analytics model is compared with the coverage of at least one other instance of the analytics model using a statistical test.

13. The computer system of claim 12, wherein the statistical test is an F-test.

14. The computer system of claim 8, further comprising computer program instructions to perform:
identifying one or more training sets, the one or more training being a part of a current model checkpoint object;
identifying one or more over-time model trends; and
wherein the new training data is generated by using data generator functions to combine the one or more training sets with one or more over-time model trends.

15. A computer program product for detecting trends in an analytics model, the computer program product comprising a non-transitory computer readable storage having program instructions embodied therewith, the program instructions executable by a computer, to cause the computer to perform a method comprising:
receiving data representing pre-existing instances of an analytics model developed over time;
detecting changes in state of the analytics model over time to detect trends;
generating a new instance of the analytics model that has been modified based on detected trends in the analytics model;
generating new training data based on discovered trends of the analytics model over time;
comparing a coverage of the new instance of the analytics model and coverages of the pre-existing instances of the analytics model with the new training data; and
determining whether new instance of the analytics model have better coverage than the pre-existing instances of the analytics model with the new training data.

16. The computer program product of claim 15, wherein the analytics model comprises behavioral data.

17. The computer program product of claim 16, wherein the analytics model is modified so as to reflect changes in the behavioral data.

18. The computer program product of claim 16, wherein the analytics model further comprises an analytic component, the analytic component being associated with metadata, wherein the metadata comprises a description of an analytic technique used by the analytics model, assumptions required for the analytic technique to be valid, constraints on the analytics model, sensitivities of the analytics model, a definition of a type of data on which the analytics model operates, and a definition of an output the analytics model produces.

19. The computer program product of claim 15, wherein the coverage of the new instance of the analytics model is compared with the coverage of at least one other instance of the analytics model using a statistical test.

20. The computer program product of claim 19, wherein the statistical test is an F-test.
